(19) United States
(12) Patent Application Publication
(10) Pub. No.: US 2026/0072227 A1
(43) Pub. Date: Mar. 12, 2026

(54) OPTICAL FIBER DISC OPTICAL FIBER CONNECTOR BOX

(71) Applicant: ACCELIGHT TECHNOLOGIES (WUHAN) INC., Wuhan (CN)

(72) Inventors: GONG-EN GU, Wuhan (CN); Matthew John Steven Rouleau, Wuhan (CN); Neil Santos, Wuhan (CN); William Sterling, Wuhan (CN); Iuliu Cosmin Gordea, Wuhan (CN); Hengzhi FAN, Wuhan (CN); Wenbing ZHU, Wuhan (CN); Zhehuanyan MEI, Wuhan (CN); Fei LI, Wuhan (CN)

(73) Assignee: ACCELIGHT TECHNOLOGIES (WUHAN) INC., Wuhan (CN)

(21) Appl. No.: 19/372,987

(22) Filed: Oct. 29, 2025

(30) Foreign Application Priority Data
May 23, 2025 (CN) 202510671587.7

(51) Int. Cl. G02B 6/44

(52) U.S. Cl. CPC G02B 6/4447

(57) ABSTRACT

An optical fiber disc optical fiber connector box includes an expansion optical fiber disc and a clamping member for connecting a heat-shrinkable sleeve or an optical device PLC. The clamping member includes a base plate. A plurality of clamping pieces arranged in parallel at intervals along an X-axis direction are disposed on an end face of one side of the base plate, and at least one guide sliding table and at least one connecting boss are disposed on an end face of the other side of the base plate. A first guide hole is disposed in the middle of the expansion optical fiber disc, and the first guide hole extends along the X-axis direction. A plurality of clamping member connecting hole groups arranged at intervals along the X-axis direction are disposed on both sides of the first guide hole.

### CROSS-REFERENCE TO RELATED APPLICATIONS

This application claims priority to Chinese Patent Application No. 202510671587.7 with a filing date of May 23, 2025. The content of the aforementioned application, including any intervening amendments thereto, is incorporated herein by reference.

### TECHNICAL FIELD

This disclosure relates to the technical field of optical fibers, and in particular, to an optical fiber disc optical fiber connector box.

### BACKGROUND

An optical fiber disc optical fiber connector box is an indispensable key connection and protection apparatus in an optical fiber communication network, and is widely applied to different laying manners such as overhead, pipeline and directly buried laying of various optical cables. The optical fiber connector box mainly provides continuous protection for optical continuity, sealing performance and mechanical strength, and is a core device for realizing straight-through and branch connection of the optical cables. The traditional optical fiber disc optical fiber connector box is usually made of synthetic plastic, has excellent performance such as high strength, corrosion resistance, and water resistance, and can meet requirements of various application scenarios such as communication, network systems, and cable televisions.

Although an optical fiber disc optical fiber connector box in the prior art may implement positioning and mounting of a heat-shrinkable sleeve or an optical device planar light-wave circuit (PLC), assembly positions inside the optical fiber connector box for fixing the heat-shrinkable sleeve or the optical device PLC are all fixed. As a result, assembly positions of the heat-shrinkable sleeve or the optical device PLC cannot be adjusted according to requirements of actual situations, thus affecting the universality of the optical fiber disc optical fiber connector box.

### SUMMARY

The technical problem to be solved in this disclosure is to provide an optical fiber disc optical fiber connector box, aiming at defects in the prior art, which has the advantages of simple structure, convenient assembly, and good compatibility.

A technical solution adopted by this disclosure to solve the technical problem is as follows: this disclosure provides an optical fiber disc optical fiber connector box, including an expansion optical fiber disc and a clamping member for connecting a heat-shrinkable sleeve or an optical device PLC, where the clamping member includes a base plate, a plurality of clamping pieces arranged in parallel at intervals along an X-axis direction are disposed on an end face of one side of the base plate, at least one guide sliding table and at least one connecting boss are disposed on an end face of the other side of the base plate, a first guide hole is disposed in the middle of the expansion optical fiber disc, the first guide hole extends along the X-axis direction, a plurality of clamping member connecting hole groups arranged at intervals along the X-axis direction are disposed on both sides of the first guide hole, and each clamping member connecting hole group includes a second guide hole arranged in one-to-one correspondence with the guide sliding table and a clamping member fixing hole arranged in one-to-one correspondence with the connecting boss; and each second guide hole extends along a Y-axis direction, each second guide hole is in communication with the first guide hole, and the clamping member fixing hole is located between the two second guide holes and is not in communication with the first guide hole.

In a preferred embodiment of this disclosure, a length of the guide sliding table in the Y-axis direction corresponds to a width of the first guide hole in the Y-axis direction.

In a preferred embodiment of this disclosure, a width of the guide sliding table in the X-axis direction corresponds to a width of the second guide hole in the X-axis direction.

In a preferred embodiment of this disclosure, the base plate is provided with the two guide sliding tables arranged in parallel at intervals along the X-axis direction and the connecting boss located between the two guide sliding tables.

In a preferred embodiment of this disclosure, each clamping piece includes a vertical plate portion arranged perpendicular to the base plate, both sides of the vertical plate portion are provided with blocking pieces arranged in mirror symmetry, and an obtuse angle is formed between the blocking piece and the vertical plate portion.

In a preferred embodiment of this disclosure, a side end face of the blocking piece is provided with a rubber clamping boss.

In a preferred embodiment of this disclosure, at least one side end face of the vertical plate portion is provided with clamping bosses arranged at intervals along a Z-axis direction.

In a preferred embodiment of this disclosure, the clamping piece is made of an elastically deformable material.

In a preferred embodiment of this disclosure, a shape of the clamping member fixing hole corresponds to a shape of the connecting boss.

In a preferred embodiment of this disclosure, the expansion optical fiber disc is connected to an expanded optical fiber disc extension bracket through an adapter hinge.

In a preferred embodiment of this disclosure, the expanded optical fiber disc extension bracket includes a bottom plate and a support plate arranged at an included angle with the bottom plate, the support plate is provided with a plurality of hinge mounting grooves arranged at equal intervals along an inclination direction thereof, and one end of each hinge mounting groove is provided with a limiting baffle.

In a preferred embodiment of this disclosure, an optical fiber disc bracket can be disposed on the expanded optical fiber disc extension bracket, the optical fiber disc bracket includes a support portion and two bosses arranged at intervals along the X-axis direction disposed on the support portion, a length of each boss in the X-axis direction corresponds to a groove width of the hinge mounting groove in the X-axis direction, a height of each boss in the Z-axis direction is not greater than a groove depth of the hinge mounting groove in the Z-axis direction, and spacing between the two bosses corresponds to spacing between two adjacent hinge mounting grooves.

Beneficial effects of this disclosure are as follows: the optical fiber disc optical fiber connector box provided by this disclosure has significant technical innovation and practical value. Compared with traditional fixed optical fiber connector boxes, the greatest technical breakthrough of this disclosure lies in realizing flexible positioning and adjustable assembly of the heat-shrinkable sleeve or the optical device PLC. According to this disclosure, the accurate adjustment of the assembly position of the heat-shrinkable sleeve or the optical device PLC is realized by designing the elaborate guide sliding table, connecting boss, guide hole, and clamping member connecting hole in the expansion optical fiber disc and the clamping member, which greatly improves the universality and adaptability of the optical fiber connector box.

In terms of structural design, the optical fiber connector box adopts a modular innovative layout. The base plate of the clamping member is provided with the plurality of clamping pieces arranged in parallel at intervals along the X-axis, and each clamping piece is further equipped with the blocking piece and the rubber clamping boss, which can not only accurately fix the optical device, but also provide good shock absorption and anti-skid performance. The precision design of the guide hole and clamping member connecting hole in the expansion optical fiber disc enables accurate positioning of the heat-shrinkable sleeve or the optical device PLC in the Y-axis and X-axis directions, which greatly enhances the mounting flexibility of the connector box.

In addition, according to this disclosure, the functionality of the optical fiber connector box is further expanded through the design of the adapter hinge and the expanded optical fiber disc extension bracket. The plurality of hinge mounting grooves and the limiting baffle disposed on the bracket not only enhance the stability of the structure, but also provide an accurate positioning mechanism for the mounting of the subsequent optical fiber disc bracket. The modular and adjustable design concept not only meets the requirements of diversified application scenarios such as communication, network systems, cable television, etc. but also provides higher flexibility and reliability for key connection devices in optical fiber communication networks.

Through these innovative designs, this disclosure effectively solves the technical limitation of the fixed assembly position of the traditional optical fiber disc optical fiber connector box, significantly improves the universality, flexibility and adaptability of the device, and provides important technical support for the refined and intelligent construction of optical fiber communication infrastructure.

### BRIEF DESCRIPTION OF THE DRAWINGS

This disclosure is further described below with reference to the accompanying drawings and embodiments, in the accompanying drawings:

FIG. 1 is a schematic assembly diagram of an expansion optical fiber disc of an optical fiber disc optical fiber connector box according to this disclosure;

FIG. 2 is a schematic diagram of an expansion optical fiber disc of an optical fiber disc optical fiber connector box according to this disclosure;

FIG. 3 is a top view of an expansion optical fiber disc of an optical fiber disc optical fiber connector box according to this disclosure;

FIG. 4 is a partial enlarged view of FIG. 3;

FIG. 5 is a schematic diagram of a clamping member of an optical fiber disc optical fiber connector box according to this disclosure;

FIG. 6 is a schematic diagram of a clamping member of an optical fiber disc optical fiber connector box according to this disclosure;

FIG. 7 is a schematic diagram of a use state of an optical fiber disc bracket of an optical fiber disc optical fiber connector box according to this disclosure;

FIG. 8 is a schematic diagram of an optical fiber disc bracket of an optical fiber disc optical fiber connector box according to this disclosure; and

FIG. 9 is a schematic diagram of an optical fiber disc bracket of an optical fiber disc optical fiber connector box according to this disclosure.

### DETAILED DESCRIPTION OF THE EMBODIMENTS

To make the purposes, technical solutions, and advantages of this disclosure clearer, the following further describes this disclosure in detail with reference to the accompanying drawings and embodiments. It should be understood that the specific embodiments described herein are merely intended to explain this disclosure, but not to limit this disclosure.

### Embodiment 1

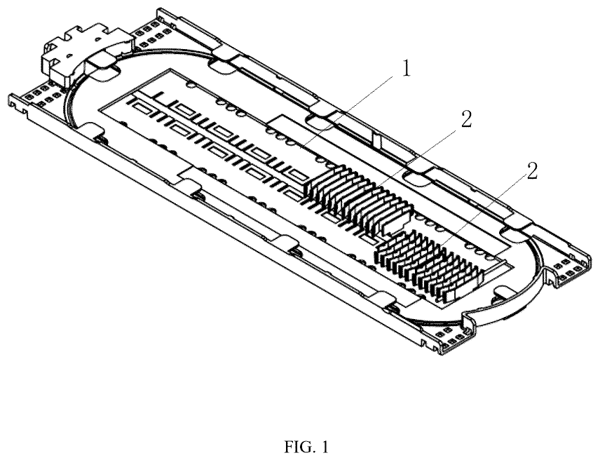

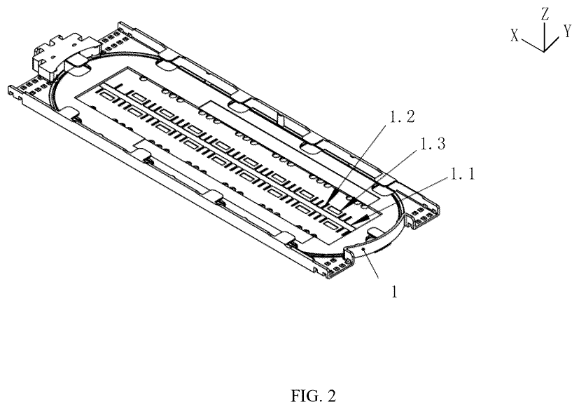

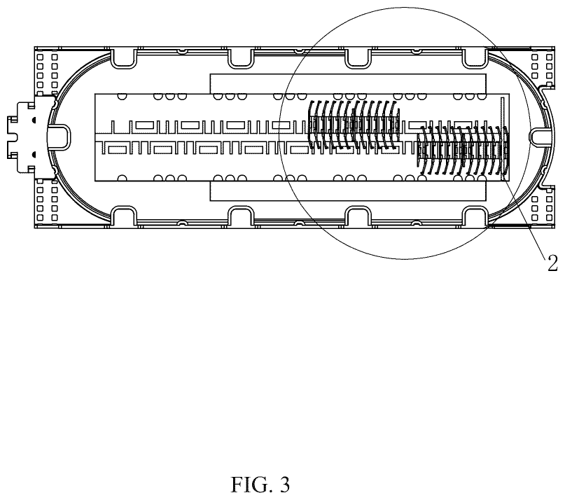

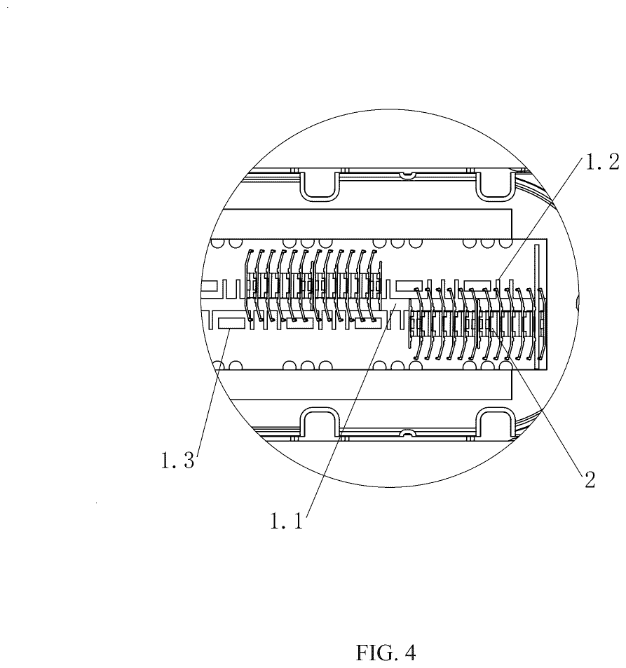

As shown in FIG. 1 to FIG. 4, this disclosure relates to an optical fiber disc optical fiber connector box, including an expansion optical fiber disc 1, a clamping member 2, an adapter hinge 3, and an expanded optical fiber disc extension bracket 4. This disclosure is intended to solve the technical limitation of the fixed assembly position of the traditional optical fiber connector box. Through an innovative modular design, the flexible positioning and accurate adjustment of a heat-shrinkable sleeve or an optical device PLC are realized.

As shown in FIG. 1 to FIG. 4, the expansion optical fiber disc 1 of this disclosure is one of the core components of this disclosure, and its design embodies the technical characteristics of precision guidance and flexible connection. The middle of the component is provided with a first guide hole 1.1 extending along the X-axis direction, and the main function of the first guide hole 1.1 is to realize the sliding guidance of the clamping member 2 in the X-axis direction. A plurality of clamping member connecting hole groups arranged at intervals along the X-axis direction are uniformly disposed on both sides of the first guide hole 1.1. Each clamping member connecting hole group is composed of two key elements: a second guide hole 1.2 arranged in one-to-one correspondence with the guide sliding table 2.3, and a clamping member fixing hole 1.3 arranged corresponding to the connecting boss 2.4. The second guide hole 1.2 extends along the Y-axis and is in communication with the first guide hole 1.1, and the clamping member fixing hole 1.3 is located between the two second guide holes 1.2 and is not in communication with the first guide hole 1.1. The carefully designed structure enables the second guide hole 1.2 to realize the sliding guidance of the clamping member 2 in the Y-axis direction, and at the same time, the connecting boss 2.4 is limited to be smoothly embedded into the clamping member fixing hole 1.3 in the X-axis direction.

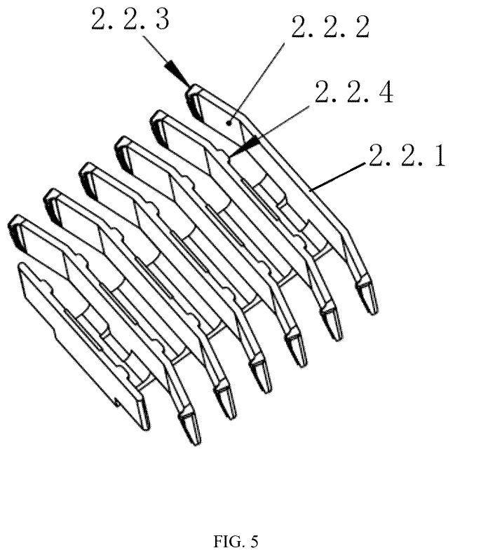

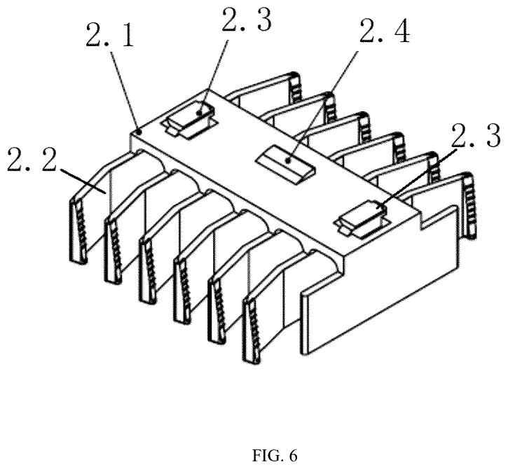

As shown in FIG. 5 to FIG. 6, the clamping member 2 of this disclosure includes a base plate 2.1. A plurality of clamping pieces 2.2 arranged in parallel at intervals along an X-axis direction are disposed on an end face of one side of the base plate 2.1, and an end face of the other side of the base plate is symmetrically provided with two guide sliding tables 2.3 and one connecting boss 2.4. Each clamping piece 2.2 is composed of a vertical plate portion 2.2.1 arranged perpendicular to the base plate 2.1. Mirror-symmetrical blocking pieces 2.2.2 are disposed on both sides of the vertical plate portion 2.2.1, and an obtuse angle is formed between the vertical plate portion and the blocking piece. A side end face of the blocking piece 2.2.2 is provided with a rubber clamping boss 2.2.3, and at least one side end face of the vertical plate portion 2.2.1 is further provided with clamping bosses 2.2.4 arranged at intervals along a Z-axis direction. These carefully designed details not only enhance the fixing ability of the clamping piece 2.2, but also provide good shock absorption and anti-skid performance. It is worth noting that the clamping piece 2.2 is made of an elastically deformable material, which further improves adaptability and flexibility of the clamping piece.

The normal state of the clamping piece 2.2 of this disclosure is in a downward-inclined state. When the heat-shrinkable sleeve or the PLC device is mounted, the baffle is spread open, and the heat-shrinkable sleeve or the device is clamped by the elastic deformation of the baffle, so that the heat-shrinkable sleeve or the device will not easily fall off. The rubber clamping boss 2.2.3 of this disclosure can increase the friction force, so that the heat-shrinkable sleeve or the device is clamped more firmly. The clamping boss 2.2.4 of this disclosure can restrict the heat-shrinkable sleeve or the device from easily popping out of a clamping groove. Compared with a conventional clamping groove used on the market at present, the clamping groove has a more reasonable structural design and there is more available internal space, enabling the clamping member to bear more heat-shrinkable sleeves (at present, one groove opening of the conventional equivalent clamping groove can bear two heat-shrinkable sleeves, and a total of six groove openings can bear 12 heat-shrinkable sleeves; and one clamping groove of the new-type clamping member can bear three heat-shrinkable sleeves, and a total of six groove openings can bear 18 heat-shrinkable sleeves), so that the bearing capacity of the disc is larger, and the product has more market potential. Meanwhile, compared with the conventional disc, the first guide hole 1.1 of this disclosure facilitates the mounting of the clamping member, allowing the clamping member to be more easily placed into a guide rail groove, thereby facilitating the mounting of the clamping member. The two columns of second guide holes 1.2 involved in this disclosure can guide the clamping member to be guided into the clamping groove, thereby meeting the requirement of mounting the clamping member from two directions and adapting to different product mounting needs. The disc of this disclosure can be more compact in use, and the heat-shrinkable sleeve clamping member can be adapted to different positions according to actual product conditions, so that the application of the disc is more flexible.

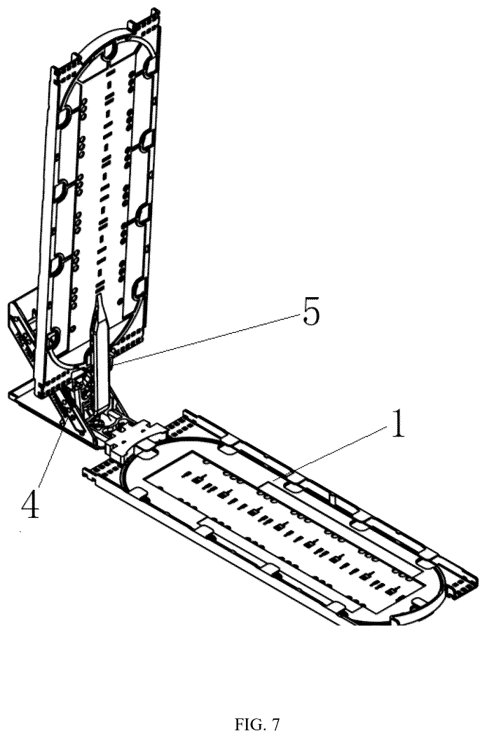

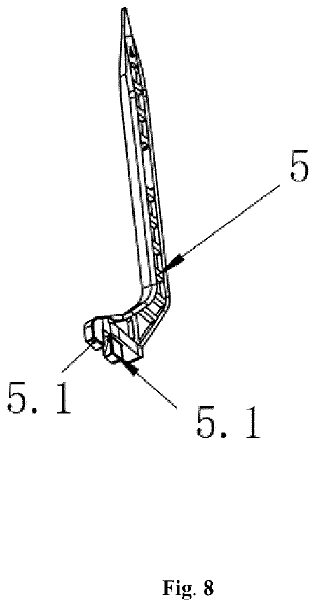

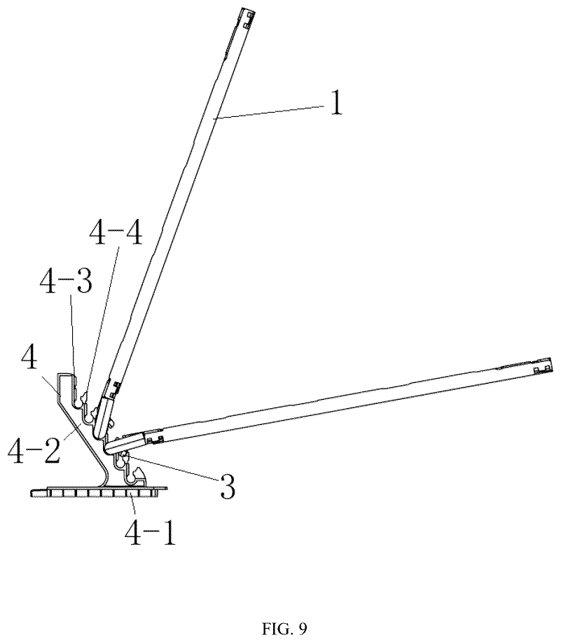

As shown in FIG. 7 to FIG. 9, the functionality of the optical fiber connector box is further expanded through the design of the adapter hinge 3 and the expanded optical fiber disc extension bracket 4 of this disclosure. The expanded optical fiber disc extension bracket 4 is composed of a bottom plate 4-1 and a support plate 4-2 arranged at an included angle with the bottom plate. The support plate 4-2 is provided with a plurality of hinge mounting grooves 4-3 arranged at equal intervals along an inclination direction thereof, and one end of each hinge mounting groove 4-3 is further provided with a limiting baffle 4-4. This design not only enhances the stability of the structure, but also provides an accurate positioning mechanism for the mounting of the subsequent optical fiber disc bracket 5. The optical fiber disc bracket 5 includes a support portion and two bosses 5.1 arranged at intervals along the X-axis direction, and its design is accurately matched with the size and spacing of the hinge mounting groove 4-3, thereby ensuring the accuracy and reliability of mounting.

According to this disclosure, through the innovative combination of the expansion optical fiber disc 1, the clamping member 2, the adapter hinge 3, and the expanded optical fiber disc extension bracket 4, the flexible adjustment of the assembly position of the optical fiber connector box is realized. Whether it is the heat-shrinkable sleeve or the optical device PLC, accurate positioning can be achieved through precise guiding mechanisms and clamping structures. The modular and adjustable design concept not only meets the requirements of diversified application scenarios such as communication, network systems, cable television, etc. but also provides higher flexibility and reliability for key connection devices in optical fiber communication networks. Compared with traditional fixed optical fiber connector boxes, this disclosure has significant advantages in terms of universality, flexibility, and adaptability, providing important technical support for the refined and intelligent construction of optical fiber communication infrastructure.

### Embodiment 2

In this embodiment, the structure of the clamping member 2 of the optical fiber disc optical fiber connector box has undergone systematic innovation. The clamping piece 2.2 is made of a high-performance PEEK (polyether ether ketone) composite material, with a composite ratio of 85% PEEK resin and 15% glass fiber, which significantly improves the mechanical strength and temperature resistance of the material. The thickness of the vertical plate portion 2.2.1 is designed to be 2.5 mm, ensuring sufficient structural strength while maintaining light weight. To enhance multi-scenario adaptability, the side edge of the vertical plate portion 2.2.1 is designed with a trapezoidal micro-groove structure. Each micro-groove has a depth of 0.3 mm, a width of 0.2 mm, and an interval of 0.5 mm. This micro-structure can provide better dimensional stability in environments with different temperatures and humidity levels.

The rubber clamping boss 2.2.3 adopts a porous micro-foamed silica gel process, and the surface micro-structure thereof presents a dandelion down-like shape, with pore sizes of 10-30 microns. This special structure not only increases the surface contact area, but also significantly improves the gripping ability for the optical cable and the optical device. The adaptability to optical cables of different materials is further enhanced by adding a hydrophilic nano-coating on the surface of the clamping boss 2.2.3. The hardness of each clamping boss 2.2.3 is controlled at 45±5 degrees Shore A, which can adapt to temperature changes from −40° C. to 85° C.

The guide sliding table 2.3 is designed using a precision machining process, and the surface roughness thereof is controlled below Ra 0.4 microns. A self-lubricating titanium alloy coating is added to the surface of the sliding table, the friction coefficient is reduced to below 0.08, and smooth sliding of the clamping member 2 in the X-axis and Y-axis directions is ensured. An inner wall of the second guide hole 1.2 adopts a plasma spraying process, with a wear-resistant coating of ceramic zirconia added, extending the service life of the guide hole to more than 100,000 sliding cycles.

### Embodiment 3

In this embodiment, the expanded optical fiber disc extension bracket 4 is made of aviation-grade 7075 aluminum alloy through one-piece die-casting molding, with a tensile strength of 572 MPa and a yield strength exceeding 503 MPa. The bottom plate 4-1 has a thickness of 4 mm, and the support plate 4-2 has a thickness of 3.5 mm. An internal honeycomb-shaped reinforcing structure is used, which significantly enhances the overall rigidity while maintaining lightweight.

The innovative design of the hinge mounting groove 4-3 is embodied in its built-in multi-level damping and buffering system. Each mounting groove is 25 mm in length, 10 mm in width, and 6 mm in depth, with three layers of micro-spring buffering units embedded inside. The first layer is a high-elasticity polyurethane buffer pad with a thickness of 0.5 mm; the middle layer is a nickel-titanium alloy micro-spring with a wire diameter of 0.2 mm; and the outermost layer is a silica gel buffer pad with a thickness of 0.3 mm. This multi-layer buffering design can effectively absorb vibration energy in a frequency range of 20-2000 Hz, with an attenuation rate as high as 85%.

The limiting baffle 4-4 is made of a polymer composite material, with a honeycomb micro-porous structure designed inside, featuring pore sizes of 0.1-0.3 mm and a porosity of 65%. This structure not only significantly reduces the weight of the baffle, but also effectively attenuates the vibration frequency, with a vibration attenuation coefficient of up to 0.2. The adapter hinge 3 is made of imported S32750 duplex stainless steel material, which has a yield strength of 550 MPa and excellent corrosion resistance, and can remain unchanged for 1000 hours in a salt spray corrosion experiment.

The surface of the connecting boss of the optical fiber disc bracket 5 is coated with a plasma-sprayed ceramic coating. The coating has a thickness of 0.08 mm and is composed of composite materials such as zirconia and alumina. The coating hardness can reach 1200 HV, which significantly improves wear resistance, with the friction coefficient as low as 0.1. The surface of the connecting boss is designed with a micro-scale anti-slip texture, with a texture depth of 0.05 mm and spacing of 0.2 mm, thereby further enhancing connection stability.

Through multi-dimensional innovations in materials, structures, and processes, these two extended embodiments comprehensively improve the performance and reliability of the optical fiber connector box, providing a more refined and reliable technical solution for different application scenarios.

It can be understood that the box body, the end cover assembly, and the hoop assembly not specifically described in this disclosure all belong to the prior art, and a mutual connection relationship and a connection manner among the box body, the end cover assembly, and the hoop assembly can refer to the content disclosed in the specification of the Chinese patent CN116609907A. Further, the disc chaining hinge 2-6 disclosed by this disclosure also belongs to the prior art, and the structure and the working principle of the disc chaining hinge can refer to the content disclosed in the specification of the Chinese patent CN116125614A.

In the description of this disclosure, it should be noted that, the orientations or positional relationships indicated by the terms “up”, “down”, etc. are based on those shown in the accompanying drawings, intended only for the convenience of describing this disclosure and for simplifying the description, and not intended to indicate or imply that the referred apparatus or element must be provided with a particular orientation or constructed and operated with a particular orientation, therefore not allowed to be construed as a limitation of this disclosure. Unless otherwise explicitly specified and limited, the terms “mounted”, “attached”, “connected” should be understood in a broad sense, e.g., it may be a fixed connection, a detachable connection or an integral connection; it may be a mechanical connection or an electrical connection; it may be a direct attachment, or an indirect attachment through an intermediate medium; and it may be a communication within two elements. For those of ordinary skill in the art, the specific meanings of the above terms in this disclosure can be understood on a case-by-case basis.

It should be noted that in this disclosure, relational terms such as “first” and “second” are used merely to distinguish one entity or operation from another entity or operation and do not necessarily require or imply the existence of any such actual relationship or sequence between these entities or operations. Moreover, the terms “include”, “comprise”, or any other variants thereof are intended to cover non-exclusive inclusion, so that a process, method, item, or device including a series of elements includes not only those elements but also other elements not explicitly listed, or further includes inherent elements of such process, method, item, or device. An element preceded by “includes a . . . ” does not, without more constraints, preclude the existence of additional identical elements in the process, method, article, or device that includes the element.

The foregoing descriptions are merely specific implementations of this disclosure, so that a person skilled in the art can understand or implement this disclosure. Various modifications to these embodiments will be readily apparent to those skilled in the art, and the general principles defined herein may be implemented in other embodiments without departing from the spirit or scope of this disclosure. Therefore, this disclosure will not be limited to the embodiments shown herein but is to be accorded the widest scope consistent with the principles and novel features of disclosed herein.

What is claimed is:

1. An optical fiber disc optical fiber connector box, comprising an expansion optical fiber disc (1) and a clamping member (2) for connecting a heat-shrinkable sleeve or an optical device planar light-wave circuit (PLC), wherein the clamping member (2) comprises a base plate (2.1), a plurality of clamping pieces (2.2) arranged in parallel at intervals along an X-axis direction are disposed on an end face of one side of the base plate (2.1), at least one guide sliding table (2.3) and at least one connecting boss (2.4) are disposed on an end face of another side of the base plate (2.1), a first guide hole (1.1) is disposed in a middle of the expansion optical fiber disc (1), the first guide hole (1.1) extends along the X-axis direction, a plurality of clamping member connecting hole groups arranged at intervals along the X-axis direction are disposed on both sides of the first guide hole (1.1), and each clamping member connecting hole group comprises a second guide hole (1.2) arranged in one-to-one correspondence with the guide sliding table (2.3) and a clamping member fixing hole (1.3) arranged in one-to-one correspondence with the connecting boss (2.4); and each second guide hole (1.2) extends along a Y-axis direction, each second guide hole (1.2) is in communication with the first guide hole (1.1), and the clamping member fixing hole (1.3) is located between two adjacent second guide holes (1.2) and is not in communication with the first guide hole (1.1).

2. The optical fiber disc optical fiber connector box according to claim 1, wherein a length of the guide sliding table (2.3) in the Y-axis direction corresponds to a width of the first guide hole (1.1) in the Y-axis direction; and a width of the guide sliding table (2.3) in the X-axis direction corresponds to a width of the second guide hole (1.2) in the X-axis direction.

3. The optical fiber disc optical fiber connector box according to claim 1, wherein the base plate (2.1) is provided with two guide sliding tables (2.3) arranged in parallel at intervals along the X-axis direction and the connecting boss (2.4) located between the two guide sliding tables (2.3); and each clamping piece (2.2) comprises a vertical plate portion (2.2.1) arranged perpendicular to the base plate (2.1), both sides of the vertical plate portion (2.2.1) are provided with blocking pieces (2.2.2) arranged in mirror symmetry, and an obtuse angle is formed between each of the blocking pieces (2.2.2) and the vertical plate portion (2.2.1).

4. The optical fiber disc optical fiber connector box according to claim 3, wherein a side end face of each blocking piece (2.2.2) is provided with a rubber clamping boss (2.2.3).

5. The optical fiber disc optical fiber connector box according to claim 3, wherein at least one side end face of the vertical plate portion (2.2.1) is provided with clamping bosses (2.2.4) arranged at intervals along a Z-axis direction.

6. The optical fiber disc optical fiber connector box according to claim 3, wherein the clamping piece (2.2) is made of an elastically deformable material.

7. The optical fiber disc optical fiber connector box according to claim 1, wherein a shape of the clamping member fixing hole (1.3) corresponds to a shape of the connecting boss (2.4).

8. The optical fiber disc optical fiber connector box according to claim 1, wherein the expansion optical fiber disc (1) is connected to an expanded optical fiber disc extension bracket (4) through an adapter hinge (3).

9. The optical fiber disc optical fiber connector box according to claim 8, wherein the expanded optical fiber disc extension bracket (4) comprises a bottom plate (4-1) and a support plate (4-2) arranged at an included angle with the bottom plate (4-1), the support plate (4-2) is provided with a plurality of hinge mounting grooves (4-3) arranged at equal intervals along an inclination direction thereof, and one end of each hinge mounting groove (4-3) is provided with a limiting baffle (4-4).

10. The optical fiber disc optical fiber connector box according to claim 9, wherein an optical fiber disc bracket (5) is disposed on the expanded optical fiber disc extension bracket (4), the optical fiber disc bracket (5) comprises a support portion and two bosses (5.1) arranged at intervals along the X-axis direction disposed on the support portion, a length of each boss (5.1) in the X-axis direction corresponds to a groove width of the hinge mounting groove (4-3) in the X-axis direction, a height of each boss (5.1) in the Z-axis direction is not greater than a groove depth of the hinge mounting groove (4-3) in the Z-axis direction, and spacing between the two bosses (5.1) corresponds to spacing between two adjacent hinge mounting grooves
